(19) United States
(12) Patent Application Publication
(10) Pub. No.: US 2009/0148734 A1
(43) Pub. Date: Jun. 11, 2009

(54) Power system using water as fuel

(76) Inventors: Ruey-Li Wang, Taipei City (TW); Yung-Chi Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,215

(22) Filed: Dec. 11, 2007

(51) Int. Cl. H01M 8/18

(52) U.S. Cl. 429/21

(57) ABSTRACT

A power system includes a power supply unit, a hydrogen oxygen generator that has an electrolytic chamber and positive electrode module and negative electrode module mounted in the electrolytic chamber and electrically connected to the power supply unit to electrolyze an electrolytic solution into a gas of hydrogen and oxygen, a storage unit for storing generated gas of hydrogen and oxygen generated, a nozzle connected to the storage unit for outputting the gas of hydrogen and oxygen to a carburetor of a vaporizing system of a motion mechanism for guiding into a combustion chamber by an air intake device for combustion and explosion to move the motion mechanism, and a pressure regulator for regulating the pressure of the gas of hydrogen and oxygen outputted from the storage unit to the nozzle.

### BACKGROUND OF THE INVENTION

1. Field of the Invention

The present invention relates to a power system and more particularly, to a power system that uses water as fuel for producing power for moving a motion mechanism.

2. Description of the Related Art

Following fast development of economics and industrial activities, the quality of life of people has been greatly improved. People use different transportation vehicles for traveling between different places to perform different commercial behaviors. With the development of industry, the world has consumed a great amount of energy. Energy supplies are becoming short. Many government organizations are trying hard to find new energy sources. Before finding a new energy resource that can substitute for petroleum, existing industrial machines and motor vehicles keep consuming gas fuel. It has become a serious problem that the world is going to face another energy crisis. Further, burning gas fuel causes pollution to the environment.

### SUMMARY OF THE INVENTION

The present invention has been accomplished under the circumstances in view. It is the main object of the present invention to provide a power system, which electrolyzes water into hydrogen and oxygen for combustion to produce power for moving a motion mechanism, for example, car engine. It is another object of the present invention to provide a power system, which utilizes water as fuel, saving much the cost and eliminating pollution.

To achieve these and other objects of the present invention, the power system comprises a power supply unit; a hydrogen oxygen generator, the hydrogen oxygen generator comprising an electrolytic chamber holding an electrolytic solution, and an positive electrode module and a negative electrode module mounted in the electrolytic chamber within the electrolytic solution and respectively connected to positive and negative terminals of the power supply unit for electrolyzing the electrolytic solution into a gas of hydrogen and oxygen; a storage unit for storing the gas of hydrogen and oxygen generated by the hydrogen oxygen generator; a nozzle connected to the storage unit for outputting the gas of hydrogen and oxygen to a carburetor of a vaporizing system of a motion mechanism for guiding into a combustion chamber by an air intake device for combustion and explosion to move the motion mechanism; and a pressure regulator adapted to regulate the pressure of the gas of hydrogen and oxygen outputted from the storage unit to the nozzle.

### BRIEF DESCRIPTION OF THE DRAWINGS

FIG. 1 is a perspective view of a power system in accordance with the present invention.

FIG. 2 is an exploded view of a part of the power system in accordance with the present invention.

FIG. 3A is a perspective view of a part of the present invention, showing the positioning of the nozzle in the car engine.

FIG. 3B is a sectional view in an enlarged scale of a part of FIG. 3A.

FIG. 4 is a system block diagram of the power system in accordance with the present invention.

FIG. 5 is a system block diagram of an alternate form of the power system in accordance with the present invention.

### DETAILED DESCRIPTION OF THE PREFERRED EMBODIMENT

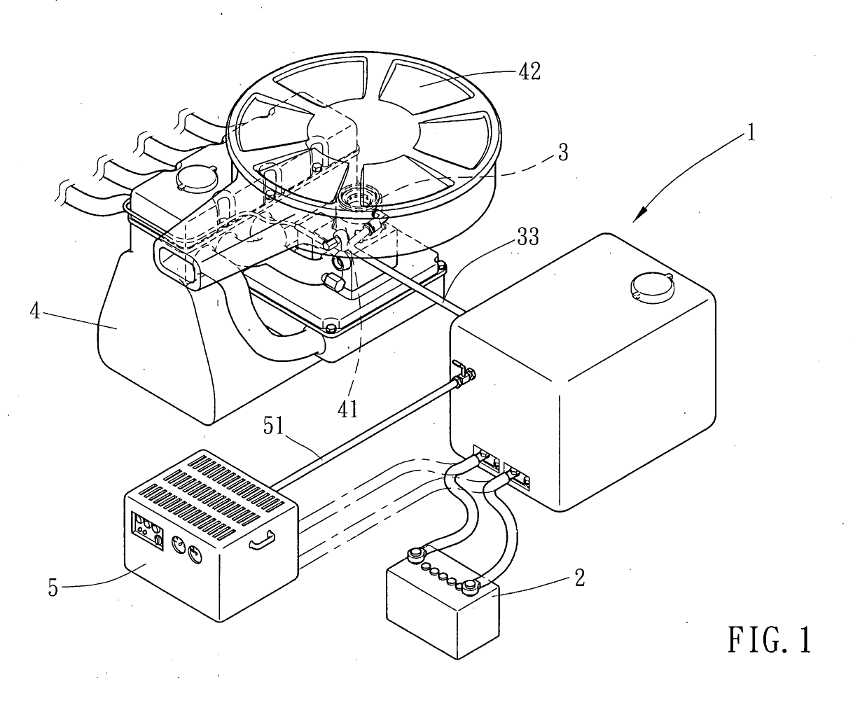

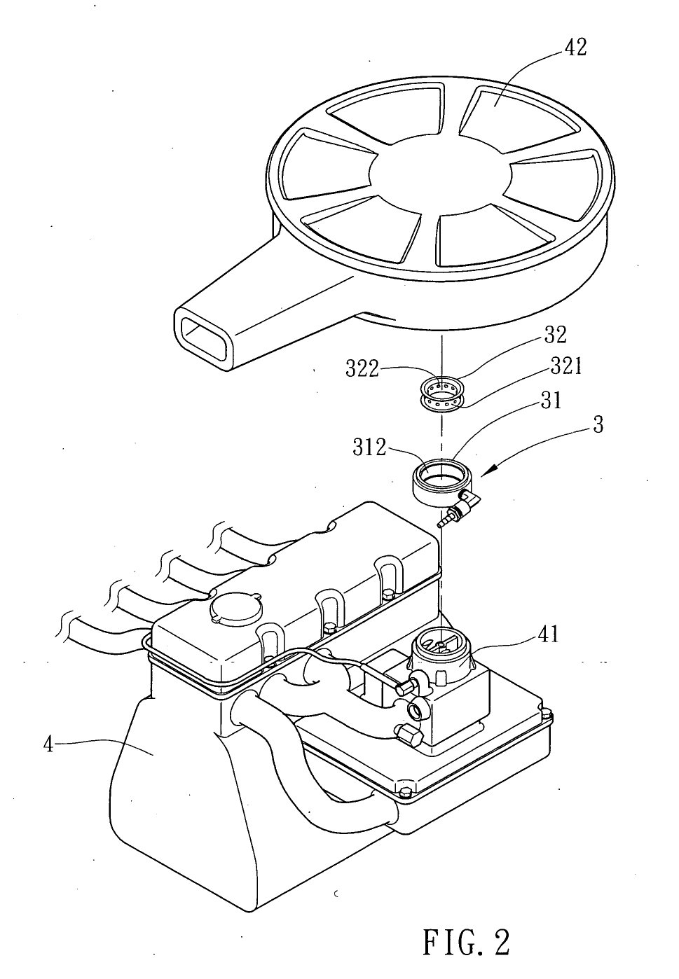

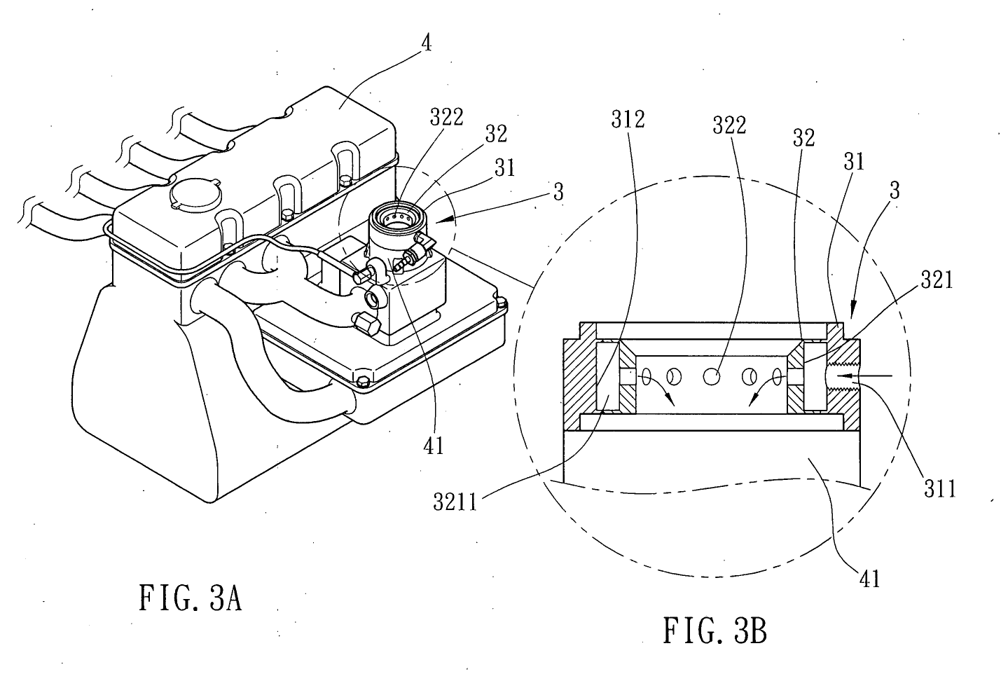

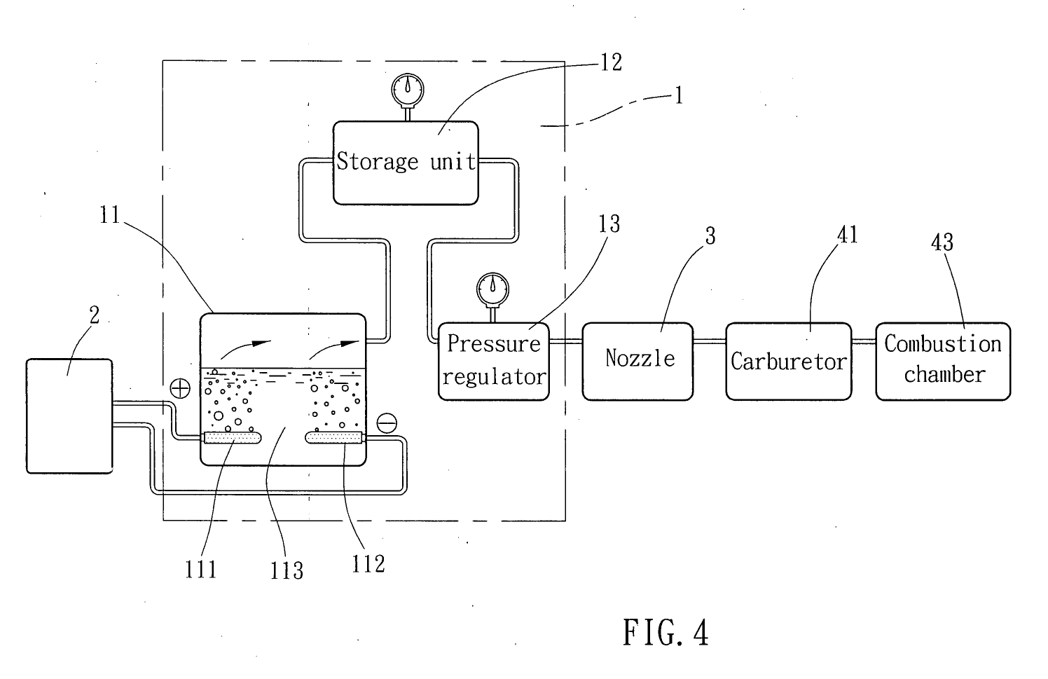

Referring to FIGS. 1˜5, a power system in accordance with the present invention is shown comprising a hydrogen oxygen generator 1, a power supply unit 2 for providing the hydrogen oxygen generator 1 with the necessary working voltage, a storage unit 12, a pressure regulator 13, and a nozzle 3 installed in the carburetor 41 of the vaporizing system of a motion mechanism, for example, car engine 4.

The hydrogen oxygen generator 1 comprises an electrolytic chamber 11 holding an electrolytic solution 113, and an positive electrode module 111 and a negative electrode module 112 mounted in the electrolytic chamber 11 within the electrolytic solution 113 and respectively connected to the positive and negative terminals of the power supply unit 2. When electric current goes through the positive electrode module 111 and the negative electrode module 112, the electrolytic solution 113 is electrolyzed into hydrogen and oxygen that are stored in the storage unit 12. Further, the power supply unit 2 has a voltage regulator for regulating the voltage supplied to the positive electrode module 111 and the negative electrode module 112, thereby adjusting the output of the hydrogen oxygen generator 1. The pressure regulator 13 is adapted to regulate the pressure of gas of hydrogen and oxygen outputted from the storage unit 12 to the nozzle 3. The nozzle 3 installed in the carburetor 41 of the vaporizing system of a motion mechanism, for example, car engine 4, which has an air intake device 42 provided above the nozzle 3 for taking in the gas of hydrogen and oxygen from the nozzle 3 for combustion and explosion in the combustion chamber 43 of the car engine 4 to move the car carrying the car engine 4.

The nozzle 3 comprises an outer race 31 defining an inside space 312, and an inner race 32 arranged within the inside space 312 of the outer race 31. The outer race 31 has a transverse air inlet 311 in air communication with the inside space 312. The inner race 32 has an endless groove 321 extending around the periphery, and a plurality of transverse air outlets 322 in air communication between the endless groove 321 and the space defined within the inner race 32. After installation of the inner race 32 in the outer race 31, an annular space 3211 is defined between the outside wall of the inner race 32 and the inside wall of the outer race 31. The storage unit 12 has its gas output side connected to the transverse air inlet 311 of the nozzle 3 by a gas tube 33. The pressure regulator 13 is installed in the gas tube 33 to regulate the pressure of gas flowing from the storage unit 12 to the nozzle 3. Therefore, the gas of hydrogen and oxygen goes through the transverse air inlet 311 of the outer race 31 into the annular space 3211 and the goes out of the annular space 3211 through the transverse air outlets 322 to the space above the carburetor 41 for suction by the air intake device 42 into the combustion chamber 43 of the car engine 4 for combustion and explosion to move the car.

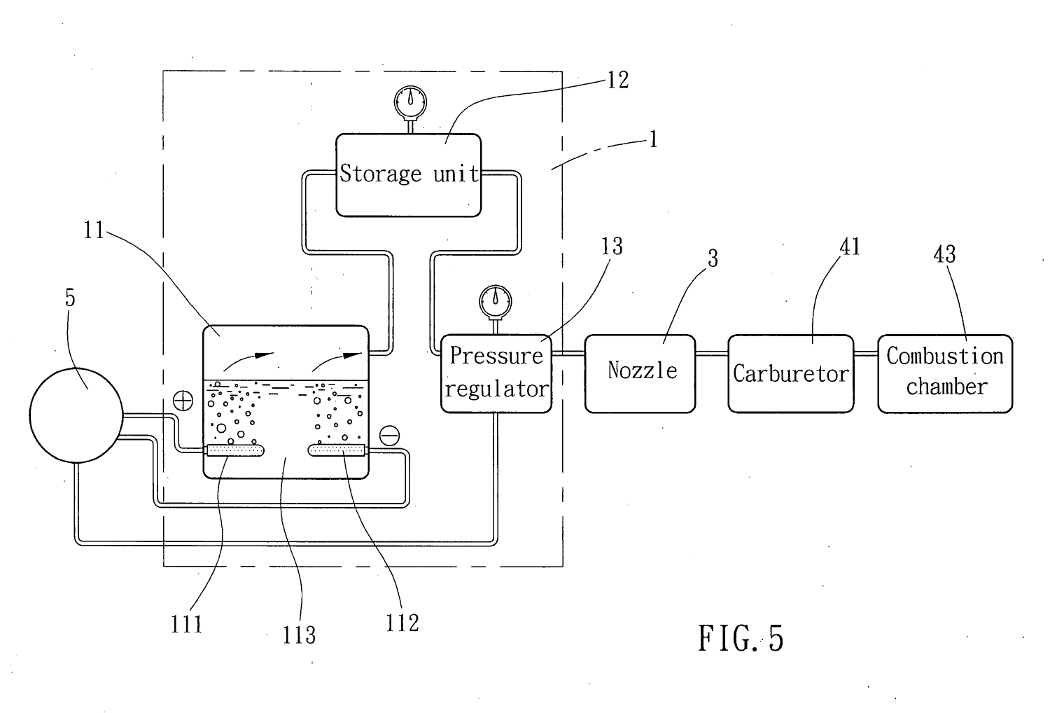

FIG. 5 shows an alternate form of the present invention. This embodiment is substantially similar to the aforesaid first embodiment with the exception of the use of a small power generator 5 to substitute for the aforesaid power supply unit 2. The small power generator 5 is used to generate electricity for the working of the hydrogen oxygen generator 1. The small power generator 5 is connected to the storage unit 12 of the hydrogen oxygen generator 1 by a gas tube 51. By means of consuming the gas of hydrogen and oxygen as fuel, the small power generator 5 works to generate electricity.

Although particular embodiments of the invention have been described in detail for purposes of illustration, various modifications and enhancements may be made without departing from the spirit and scope of the invention.

What the invention claimed is:

1. A power system comprising:
a power supply unit;
a hydrogen oxygen generator, said hydrogen oxygen generator comprising an electrolytic chamber holding an electrolytic solution, and an positive electrode module and a negative electrode module mounted in said electrolytic chamber within said electrolytic solution and respectively connected to positive and negative terminals of said power supply unit for electrolyzing said electrolytic solution into a gas of hydrogen and oxygen;
a storage unit for storing said gas of hydrogen and oxygen generated by said hydrogen oxygen generator;
a nozzle connected to said storage unit for outputting said gas of hydrogen and oxygen to a carburetor of a vaporizing system of a motion mechanism for guiding into a combustion chamber by an air intake device for combustion and explosion to move said motion mechanism; and
a pressure regulator adapted to regulate the pressure of said gas of hydrogen and oxygen outputted from said storage unit to said nozzle.

2. The power system as claimed in claim 1, wherein said electrolytic solution is water.

3. The power system as claimed in claim 1, wherein said power supply unit comprises a voltage regulator for regulating the voltage supplied to said positive electrode module and a negative electrode module.

4. The power system as claimed in claim 1, wherein said nozzle comprises an outer race defining an inside space, and an inner race arranged within said inside space of said outer race, said outer race having a transverse air inlet connected to said storage unit for guiding gas of hydrogen oxygen to said inside space, said inner race having an endless groove extending around the periphery thereof and a plurality of transverse air outlets in air communication between said endless groove and the space defined within said inner race.

5. The power system as claimed in claim 1, wherein said hydrogen oxygen generator has added positive electrode module and negative electrode module to enhance the hydrogen oxygen generating speed.

6. The power system as claimed in claim 1, further comprising a small power generator connected to said storage unit for consuming said gas of hydrogen and oxygen as fuel for generating electricity for the working of said positive electrode module and said negative electrode module of said hydrogen oxygen generator.
